(19) United States
(12) Patent Application Publication
(10) Pub. No.: US 2024/0272927 A1
(43) Pub. Date: Aug. 15, 2024

(54) METHOD FOR RESOURCE ALLOCATION FOR APPLICATIONS AND/OR APPLICATION CONTAINERS IN A DISTRIBUTED SYSTEM OF HETEROGENEOUS COMPUTE NODES

(71) Applicant: Robert Bosch GmbH, Stuttgart (DE)

(72) Inventors: Arne Hamann, Ludwigsburg (DE); Dakshina Narahari Dasari, Renningen (DE); Dirk Ziegenbein, Freiberg Am Neckar (DE); Franz-Josef Grosch, Darmstadt (DE); Michael Pressler, Karlsruhe (DE)

(21) Appl. No.: 18/499,528

(22) Filed: Nov. 1, 2023

(30) Foreign Application Priority Data
Feb. 13, 2023 (DE) 10 2023 201 143.3

(51) Int. Cl. G06F 9/455

(52) U.S. Cl. CPC G06F 9/45558; G06F 2009/4557; G06F 2009/45591

(57) ABSTRACT

A method for resource allocation for applications and/or application containers in a distributed system of heterogeneous compute nodes, which are heterogeneous at least with respect to their hardware platforms and/or operating systems. The method includes: executing one of the applications and/or the application containers based on an intermediate instruction set architecture by means of a runtime environment, wherein the runtime environment is provided on at least one of the compute nodes; carrying out resource monitoring of resource usage at the compute node by means of the runtime environment, wherein the resource monitoring is carried out based on the intermediate instruction set architecture; carrying out resource allocation based on the resource monitoring that has been carried out.

### CROSS REFERENCE

The present application claims the benefit under 35 U.S.C. § 119 of German Patent Application No. DE 10 2023 201 143.3 filed on Feb. 13, 2023, which is expressly incorporated herein by reference in its entirety.

### FIELD

The present invention relates to a method for resource allocation for applications and/or application containers in a distributed system of heterogeneous compute nodes. Furthermore, the present invention relates to a computer program and a device for this purpose.

### BACKGROUND INFORMATION

Traditional cloud and edge computing solutions allow users to deploy and run applications in the cloud or edge in different virtual execution environments, also known as containers. The virtual execution environments are hosted on servers (farms). The containers can be monitored and managed by an underlying layer called the container runtime, or runtime for short. In general, this runtime layer sits on top of the operating system. This can be viewed as a system stack consisting of the hardware layer, the operating system, the runtime and finally the containers that house the applications.

An important object of the runtime environment is to provide an isolated environment that protects the individual containers from one another and also ensures that none of the executed containers monopolizes or disproportionately consumes system resources. Accordingly, there is a need for resource management between these runtimes in order to control the use of resources such as CPU, memory or network usage.

Typically, runtimes rely on the underlying operating system to enforce mechanisms for resource usage. For example, the docker container runtime environment from the related art relies on control groups (cgroups) through the Linux operating system.

Depending on whether a specified compute node is resource-constrained or not, it can also support only some functions of the operating system. In other words, container runtimes are also limited by the capabilities of the operating system. An undesirable impact is that an edge or cloud orchestrator who needs to enforce policies for container resource management must be aware of the capabilities of the operating system and have a normalized (unified) way to specify resource requirements for different compute nodes. However, in newer edge computing scenarios where it may be necessary to deploy applications on heterogeneous devices, each with its own operating system, it can be technically challenging to implement resource allocation without a unified view of resource management.

### SUMMARY

The present invention provides a method, a computer program, and a device. Features and details of the present invention will become apparent from the disclosure herein. Here, features and details which are described in connection with the method according to the present invention also apply, of course, in connection with the computer program according to the present invention and the device according to the present invention, and vice versa in each case, so that, with regard to the disclosure, individual aspects of the present invention always refer or can refer to one another.

In particular, the present invention provides a method for resource allocation for applications and/or application containers in a distributed system of heterogeneous compute nodes. The compute nodes can be heterogeneous at least in terms of their hardware platforms and/or operating systems; i.e., they can preferably differ in terms of their hardware and/or the operating system executed on it.

With the method according to an example embodiment of the present invention, the following steps, which are preferably automated and/or carried out sequentially and/or repeatedly, can be provided:
executing at least one of the applications and/or the application containers on the basis of an intermediate instruction set architecture by means of a runtime environment, wherein the runtime environment is provided on at least one or exactly one of the compute nodes, wherein preferably the further compute nodes also each have a runtime environment for executing the applications and/or the application containers,
carrying out resource monitoring of resource usage, preferably of the executed application and/or the application container, at the compute node by means of the runtime environment, wherein preferably the resource monitoring is carried out on the basis of the intermediate instruction set architecture, in particular independently of the hardware platforms and/or the operating systems,
carrying out resource allocation, preferably for the executed application and/or the application container, on the basis of the resource monitoring that has been carried out.

This may have the advantage that a reliable means of resource monitoring and thus improved resource allocation can be enabled. It is possible that the steps are also executed for further applications and/or application containers and/or compute nodes of the distributed system.

The method according to the present invention can be provided for preferably adaptive resource allocation for applications and/or application containers in a distributed system of heterogeneous compute nodes. In this case, the compute nodes can be heterogeneous in that they have different computing capacities and/or different functionality and/or different types of hardware.

The heterogeneous compute nodes can also be formed as at least one of the following device categories:
different smaller IoT devices (IoT here stands for “Internet of Things”),
different telephones,
different cloud servers, which provide different performance, for example,
different compute nodes in edge computing, for example comprising a data processing device in a vehicle and a data processing device outside the vehicle,
different computing capacities in a SoC, i.e. system-on-chip,
different processors,
different computing capacities, such as general-purpose or special-purpose floating-point or graphics processing or acceleration capacities.

Thus, it is also possible that the distributed system comprises distributed middleware and/or different operating systems or hypervisors and/or an edge computing environment and/or an IoT environment and/or a cloud computing environment and/or a vehicle controller. It is also optionally provided that the compute nodes are at least partially mobile; i.e., they move during the execution of the method according to the present invention.

In addition to the compute nodes, according to an example embodiment of the present invention, the communication resources and/or the applications or application containers can also be heterogeneous; i.e., they provide or require different performance. Thus, the method is preferably particularly suitable for being used for a heterogeneous environment. Furthermore, the applications or application containers can also be heterogeneous and/or can also be application containers. The computing capacity can furthermore be a computing capability provided by a compute node to execute the application.

An application container, or container for short, can be defined as a sandboxed and/or controlled environment for executing an application (or a plurality of applications). The application can have limited visibility and limited access to underlying system resources when executed in the container. In this case, the limitation of access and visibility can be specified by the underlying container runtime.

A further advantage can be obtained within the framework of the present invention if the runtime environment carries out management of the executed application and/or the application container and isolates the executed application and/or the application container from the other applications and/or application containers in the distributed system. In this case, the other applications and/or application containers can also be executed by respective runtime environments of the respective compute nodes. Corresponding resource monitoring can also be provided for these in accordance with the method according to the present invention. Within the framework of the present invention, a runtime, preferably also known as runtime environment and/or container runtime, can be understood as a management layer for managing the lifecycle of containers. Management can comprise, for example, starting and/or shutting down and/or restarting and/or terminating the containers or applications executed therein. Furthermore, the container runtime can be used to isolate between containers and to monitor resource usage, resource access and resource visibility of individual containers. Within the system stack, this generally allows the container runtime to override the operating system and use the operating system's functions to enforce resource control.

According to an example embodiment of the present invention, the distributed system can be implemented as a cloud computing system. In particular, cloud computing systems are systems for data processing that are provided at least partially at a location remote from the user. While the “cloud” appears to the user as a single logical computer, it can comprise a plurality of compute nodes, referred to as nodes for short, each of which can execute applications and/or containers. Each compute node can thus host a container runtime. Users can establish a connection to a cloud interface and deploy their application and/or container. A dedicated cloud orchestrator can allocate the application and/or application container to a suitable node. Typically, clouds are characterized by a huge cluster of uniform nodes with high computing capacities.

According to an example embodiment of the present invention, the distributed system can be implemented as an edge computing system. Edge computing offers a further option for deploying applications and/or containers. The edge typically refers to a location closer to the user or application and also hosts a plurality of compute nodes that can execute applications and/or containers. Users can establish a connection to the edge interface and deploy their application and/or container on the edge. A dedicated edge orchestrator can then allocate the incoming application and/or container to a suitable node. Typically, edge computing is characterized by a huge cluster of different heterogeneous nodes (from microcontrollers to single-board computers to large servers) with different computing capabilities. Edge computing offers the advantage of reducing the amount of outgoing data, for example in order to reduce the latency period due to long round-trip times to a remote site.

Furthermore, according to an example embodiment of the present invention, an instruction set architecture and in particular intermediate instruction set architecture can be used by the runtime. In general, an instruction set architecture (ISA for short) for a specified physical architecture such as x86, ARM, etc. defines the supported instructions and/or data types and/or registers and/or hardware support for main memory management and/or underlying features such as memory consistency, addressing modes and virtual memory and the input/output model of a family of implementations of the ISA.

The resource management mechanisms in traditional virtualization mechanisms are heavily dependent on the functions provided by the underlying operating system and architecture. For example, Linux operating systems support cgroups, but QNX or other operating systems have no corresponding concept. Likewise, ARM architectures have a different set of performance monitoring counters compared to Intel architectures, such that an exact allocation is not possible. In an edge computing system, which consists of different operating systems and architectures, this can lead to inconsistent ways in which resource requirements are specified and resource controls are enforced. In addition, it can be difficult to change the operating system to add newer and customized resource management mechanisms.

According to an example embodiment of the present invention, it can also be possible that the heterogeneous compute nodes have different operating systems and architectures, such that the heterogeneous compute nodes differ, in particular with respect to their resource management mechanisms, wherein uniform resource management can be provided across the different hardware platforms of the compute nodes on the basis of the intermediate instruction set architecture. In this case, the present invention can offer the advantage of enabling uniform resource management across different platforms, in particular independently of the operating system. In this case, a prerequisite can merely be that the runtime environment must be installed on the relevant compute node. Furthermore, the runtime environment can be extended to provide newer resource management mechanisms. The runtime can be enriched with its own scheduler and/or priority inheritance-like mechanisms, etc., independently of what the operating system provides. This allows the operating system layer to be streamlined.

Furthermore, according to an example embodiment of the present invention, it can be provided that the runtime environment has at least one mechanism for enforcing resources on the basis of the resource monitoring that has been carried out, preferably to terminate the executed application when a limit value is exceeded by the resource usage of the executed application. This is preferably a way to carry out resource allocation on the basis of the resource monitoring that has been carried out. In this case, mechanisms for the enforcement of resources (in particular mechanisms independent of platforms and operating systems) can advantageously be implemented on the basis of resource monitoring functions. These mechanisms can comprise at least one of the following:
enforcement of temporal isolation between executed applications in the runtime, in particular independently of capabilities of the host operating system,
execution of applications of mixed criticality (for example, best-effort and real-time applications) through enforcement of resource controls,
protection of critical applications from malfunctioning applications,
handling of shared resources across applications using protocols such as priority inheritance and priority caps.

Furthermore, with the method according to the present invention, instrumentation can optionally be provided at the byte code level (IISA level) described below, with reference to an underlying cost model. In particular, there is no dependence on the underlying hardware performance counters for instrumentation.

Within the framework of the present invention, the term instrumentation may refer to the analysis of code at different points (instrumentation points) in order to derive low-level metrics such as number of instructions, memory usage, etc.

A further advantage within the framework of the present invention is achievable if the at least one executed application and/or the at least one application container is provided in a bytecode, preferably according to an intermediate instruction set architecture, which bytecode is interpreted by the runtime environment to execute the application. In this way, the application or application container can be executed by the runtime environment on the basis of the intermediate instruction set architecture. An intermediate code can be called a bytecode. In this case, the source code can initially be compiled and/or interpreted into an intermediate format, the bytecode, and only then translated into the underlying machine instruction architecture. In this case, the bytecode can comprise a collection of instructions for a virtual machine. An example definition for a bytecode is WebAssembly (or Wasm).

In particular, it is a concept of the present invention that runtime extensions are provided for consistent resource management across different platforms. This is preferably possible through the introduction of runtime-integrated resource monitoring and enforcement capabilities, along with a mechanism for normalizing application performance across different platforms using the concept of virtual computing units.

In this case, an intermediate instruction set architecture (IISA) can be used, which is understood by the runtime. When applications are executed, the runtime environment interprets the generated IISA and then executes it on the underlying computer, in particular compute nodes. Any application executed on the runtime environment may be subject to certain resource constraints, which may be predefined (for example set by a system designer or a user). When applications are executed, the runtime environment can monitor resource usage and, if resource usage is exceeded, invoke an appropriate exception handler that either terminates or suspends the application or takes other action according to configurable policies. The container runtime environment can also provide a user-defined scheduler that sets the execution order of the different applications hosted by the runtime environment and guarantees each of such applications a specified CPU reservation.

According to a further possibility of the present invention, it can be provided that resource monitoring is carried out on the basis of a cost model which is specific to the respective hardware platforms of the compute nodes and in which preferably the costs are defined on the basis of individual intermediate instructions according to the intermediate instruction set architecture. In this way, resource monitoring can be carried out on the basis of the intermediate instruction set architecture. Performance normalization across different platforms can thus be realized via a platform-specific cost model, which is substantially a translation between IISA resource control and the underlying ISA. With the proposed structure, when a user connects to a cloud/edge interface, the orchestrator can have a unified way to specify the resource requirements for different runtimes.

It is also possible that the runtime environment is implemented as a virtual machine comprising the intermediate instruction set architecture.

It is also possible within the framework of the present invention that the application is instrumented and monitored by the runtime environment on the basis of an evaluation of intermediate instructions of the application, preferably a counting of a number of the intermediate instructions, wherein for this purpose an intermediate code, in particular bytecode, of the application is preferably supplemented by an instrumentation code.

The relevant application can, for example, provide a function for automated driving. It is therefore possible for the method according to the present invention to be used in a vehicle. The vehicle can, for example, be formed as a motor vehicle and/or passenger vehicle and/or autonomous vehicle. The vehicle can have a vehicle apparatus, for example for providing the function for automated driving and preferably an autonomous driving function. The function and/or the vehicle apparatus can be designed to control and/or accelerate and/or brake and/or steer the vehicle at least partially automatically.

The present invention also relates to a computer program, in particular a computer program product, comprising instructions which, when the computer program is executed by a computer, cause the computer to carry out the method according to the present invention. The computer program according to the present invention thus brings with it the same advantages as have been described in detail with reference to a method according to the present invention.

The present invention also relates to a device for data processing that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention. The storage medium is designed, for example, as a data store such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention will become apparent from the following description, in which exemplary embodiments of the present invention are described in detail with reference to the figures. The features disclosed herein can be essential to the present invention in each case individually or in any combination.

### BRIEF DESCRIPTION OF THE DRAWINGS

FIG. 1 shows a schematic visualization of a method, a device and a computer program according to exemplary embodiments of the present invention.

FIG. 2 shows a schematic diagram of the proposed operating system-agnostic container runtime environment according to exemplary embodiments of the present invention.

FIG. 3 shows a schematic diagram of an edge orchestration mechanism with the proposed container runtime according to exemplary embodiments of the present invention.

In the following figures, identical reference signs are also used for the same technical features of different embodiments of the present invention.

### DETAILED DESCRIPTION OF EXAMPLE EMBODIMENTS

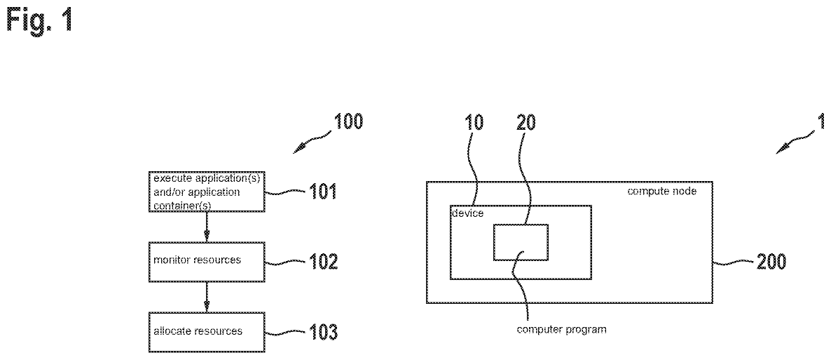

FIG. 1 illustrates, according to exemplary embodiments of the present invention, a method 100 for allocating resources for applications 50 and/or application containers 60 in a distributed system 1 of heterogeneous compute nodes 200. The compute nodes 200 can differ in terms of their hardware platforms and/or operating systems. According to a first method step 101, at least or exactly one of the applications 50 and/or the application containers 60 can be executed on the basis of an intermediate instruction set architecture by means of a runtime environment. In this case, the runtime environment can be present on at least one of the compute nodes 200. Subsequently, according to a second method step 102, resource monitoring of resource usage at the compute node 200 can be carried out by the runtime environment. In this case, resource monitoring can be provided independently of the hardware platforms and/or operating systems on the basis of the intermediate instruction set architecture. According to a third method step 103, resource allocation is then possible on the basis of the resource monitoring that has been carried out.

Furthermore, FIG. 1 shows a computer program 20 and a device 10 according to exemplary embodiments of the present invention. In this case, these can be part of the distributed system 1 and in particular one of the compute nodes 200.

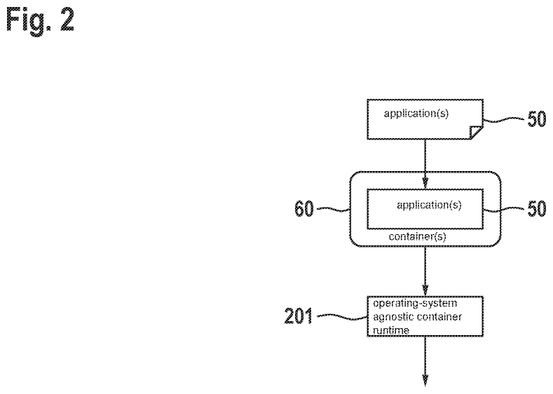

In FIG. 2, according to exemplary embodiments of the present invention, the runtime environment is shown in the form of an operating system-agnostic container runtime 201. This acts as a management layer that manages the lifecycle of containers, in particular startup, shutdown, restart, and termination. Furthermore, the runtime can provide isolation between containers and monitor the resource usage, resource access and resource visibility of each individual container. Advantageously, applications developed in different languages are not compiled directly into the machine-level format, but into an intermediate instruction set (IIS) that is understood by the runtime environment. That means that the runtime environment serves as a virtual machine comprising its own intermediate instruction set architecture (IISA). The runtime environment, in turn, interprets the generated IIS and executes it on the underlying physical machine, in particular compute nodes.

Each application that is executed on the runtime environment is subject to certain resource constraints, such as those set by a system designer (or user). When applications are executed, the runtime environment monitors resource usage and, if resource usage is exceeded, invokes a suitable exception handler that either terminates or suspends the application or takes other action according to configurable policies. The translation between the IISA resource control and the underlying ISA is performed via a platform-specific cost model.

Since the applications are compiled into the IISA, the generated IIS for a given application is the same regardless of the operating system or underlying hardware platform. This also means that applications can be instrumented and monitored agnostically at the IIS level—by counting the number of intermediate instructions.

Additional considerations for platform hardware can be made with the aid of a cost model. Therefore, the cost model is a means of normalizing execution time across different platforms. It uses the concept of virtual CPU time units (vcpu), i.e. virtual CPU time units can be derived from: the IISA generated for the runtime, the actual ISA of the underlying machine and the frequency of the machine.

One way to implement this allocation is as follows: each instruction in the IISA is mapped to an internal architecture-related machine instruction. For a given architecture, the number of cycles to execute the instruction is determined. For example, the IISA can have an instruction called Iadd that maps to the internal add instruction, which consumes 3 cycles for the given architecture.

Vcpu time units can also be defined for each platform, which units are an abstraction of the computation time of an application on this specified platform. For example, if 1 second of CPU is equal to 10\hat{ }6 vcpus, or 1 vcpu is equal to one microsecond, such an assumption can serve the purpose of normalization across different machines with different frequencies. Then, in particular, for each target machine in the distributed system, such a mapping and the costs of executing an IISA instruction in vcpu time units must be found. Such a cost model can be derived for each architecture, for example as follows:

| | IISA | ISA Opcode | Latency in | f = Frequency | vcpu |
|---|---|---|---|---|---|
| | Opcode | O2 = | Cycles L = | of | time |
| Machine | O1 | M1 (o1, X) | M2 (O2, X) | machine | units |
| X86_ | Iadd | Add | 3 | 1 GHz | .0003 |
| 1 Ghz | | | | | vcpus |
| X86_ | Imov | Mov | 1 | 1 GHz | .0001 |
| 1 Ghz | | | | | vcpus |

Furthermore, a user-defined scheduler (custom scheduler) can be provided. The proposed container runtime environment is then complemented by a user-defined scheduler that decides the order of execution of the finished applications on the runtime environment. Each application can be assigned a priority, a budget and a replenishment period. The container runtime environment preferably maintains a queue of applications ready for execution. At each scheduling event (ticking of a timer, arrival of a new application, termination/suspension of an application, arrival of an interrupt or message, or an application is blocked/released), the scheduler can search the ready queue to select the next application to execute. A user-defined scheduling mechanism can be executed as follows:
a. from the set of available applications, the scheduler filters out all applications that have not yet exhausted the budget
b. from the set of selected applications, it selects the application with the highest priority and launches it for execution.

The limits of CPU usage can be specified in the form of a budget, preferably a CPU budget in vcpu time units and a replenishment interval. The budget can specify the amount of processing (at the IISA level) that an application can execute before it is stopped. While the application is executed, its budget is used up. When it becomes zero, the application is suspended. After each refill interval, the application's budget can be fully recharged and the application can be queued again. With the mechanism described above, applications can be guaranteed a specified processing time by the underlying runtime. Furthermore, this mechanism allows safety-critical and best-effort applications to coexist on the same platform.

More generally, following the example of reservation-based scheduling, other user-defined scheduling mechanisms can be defined by the container runtime in order to schedule the execution of different applications. Depending on the number of cores available to the container runtime, the scheduler can, for example, schedule applications on each of such cores. Similarly, budgets for bandwidth and network usage can be set to limit or enforce consumption of such resources.

The applications can be compiled into an intermediate representation IISA and thus into intermediate code and/or bytecode. When monitoring is enabled, the generated IISA code can be supplemented with instrumentation code that counts the number of instructions executed and the CPU time consumed. The program can be divided into basic blocks (linear execution sequences), and instrumentation points can be added around different basic blocks, in order to add the CPU time units corresponding to the individual basic blocks. While the application is executed, its CPU consumption increases.

If the budget is exceeded, the runtime environment can handle it in several ways. For example, the runtime environment can interrupt the application, throttle or terminate execution, or use some other user-configured mechanism. A similar instrumentation can be undertaken for the use of the storage and the network.

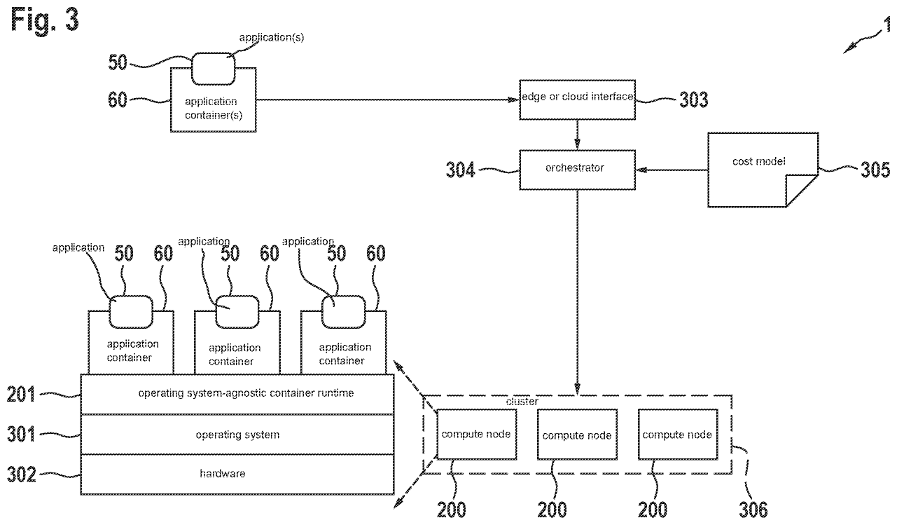

A further advantage arises from the fact that the vcpu time units are integrated into the runtime environment and do not depend on external hardware performance counters or the support of dedicated resource quota mechanisms such as cgroups in the operating system. This allows uniform resource control to be specified and enforced at the application level itself with the aid of an additional cost model. An exemplary cloud or edge orchestration setup using the proposed solution is shown in FIG. 3. In this case, 301 designates the operating system, 302 designates the hardware, 303 designates an edge and/or cloud interface, 304 designates an orchestrator, 305 designates the cost model and 306 designates a cluster of compute nodes 200.

Furthermore, the proposed solution can be used for resource management via operating systems/hypervisors and/or in vehicle computers.

The above description of the embodiments describes the present invention exclusively in the context of examples. Of course, individual features of the embodiments, provided they make technical sense, can be freely combined with one another without departing from the scope of the present invention.

What is claimed is:

1. A method for resource allocation for applications and/or application containers in a distributed system of heterogeneous compute nodes which are heterogeneous at least with respect to their hardware platforms and/or operating systems, the method comprising the following steps:
executing at least one application of the applications and/or at least one container of the application containers based on an intermediate instruction set architecture using a runtime environment, wherein the runtime environment is provided on at least one of the compute nodes;
carrying out resource monitoring of resource usage at the at least one compute node using the runtime environment, wherein the resource monitoring is carried out based on the intermediate instruction set architecture; and
carrying out resource allocation based on the resource monitoring that has been carried out.

2. The method according to claim 1, wherein the runtime environment carries out management of the executed application and/or application container and isolates the executed application and/or application container from the other applications and/or application containers in the distributed system.

3. The method according to claim 1, wherein the heterogeneous compute nodes have different operating systems and architectures, such that the heterogeneous compute nodes differ with respect to their resource management mechanisms, wherein uniform resource management is provided across the different hardware platforms of the compute nodes based on the intermediate instruction set architecture.

4. The method according to claim 1, wherein the runtime environment has at least one mechanism for enforcing resources based on the resource monitoring that has been carried out, including terminating the executed application when a limit value is exceeded by the resource usage of the executed application.

5. The method according to claim 1, wherein the executed application is provided in a bytecode, which is interpreted by the runtime environment for executing the application.

6. The method according to claim 1, wherein the resource monitoring is carried out based on a cost model which is specific to the hardware platforms of the compute nodes and in which costs are defined based on individual intermediate instructions according to the intermediate instruction set architecture.

7. The method according to claim 1, wherein the runtime environment is implemented as a virtual machine including the intermediate instruction set architecture.

8. The method according to claim 1, wherein the application is instrumented and monitored by the runtime environment based on an evaluation of intermediate instructions of the application including a counting of a number of the intermediate instructions, wherein for this purpose, an intermediate code of the application is supplemented by an instrumentation code.

9. A non-transitory computer-readable medium on which is stored a computer program including instructions for resource allocation for applications and/or application containers in a distributed system of heterogeneous compute nodes which are heterogeneous at least with respect to their hardware platforms and/or operating systems, the computer-program, when executed by a computer, causing the computer to perform the following steps:
executing at least one application of the applications and/or at least one container of the application containers based on an intermediate instruction set architecture using a runtime environment, wherein the runtime environment is provided on at least one of the compute nodes;
carrying out resource monitoring of resource usage at the at least one compute node using the runtime environment, wherein the resource monitoring is carried out based on the intermediate instruction set architecture; and
carrying out resource allocation based on the resource monitoring that has been carried out.

10. A device for data processing configured for resource allocation for applications and/or application containers in a distributed system of heterogeneous compute nodes which are heterogeneous at least with respect to their hardware platforms and/or operating systems, the device configured to:
execute at least one application of the applications and/or at least one container of the application containers based on an intermediate instruction set architecture using a runtime environment, wherein the runtime environment is provided on at least one of the compute nodes;
carry out resource monitoring of resource usage at the at least one compute node using the runtime environment, wherein the resource monitoring is carried out based on the intermediate instruction set architecture; and
carry out resource allocation based on the resource monitoring that has been carried out.
